(19) United States
(12) Patent Application Publication
(10) Pub. No.: US 2025/0279620 A1
(43) Pub. Date: Sep. 4, 2025

(54) SOCKET CONNECTION SYSTEM

(71) Applicant: Woertz AG, Muttenz (CH)

(72) Inventors: Tamas Onodi, Thalwil (CH); Beat Tschudin, Reinach (CH); Luca Castronari, Himmelried (CH)

(21) Appl. No.: 19/066,486

(22) Filed: Feb. 28, 2025

(30) Foreign Application Priority Data
Mar. 1, 2024 (EP) 24161015.3

(51) Int. Cl. H01R 24/78; H01R 4/2406; H01R 13/629; H01R 103/00; H01R 105/00

(52) U.S. Cl. CPC H01R 24/78; H01R 4/2406; H01R 13/62955; H01R 13/62994; H01R 2103/00; H01R 2105/00

(57) ABSTRACT

A connection system for a socket, wherein the connection system comprises a junction box for electrically connecting the socket to a flat cable as a through-line and wherein the socket can be placed directly onto the junction box. The junction box comprises multiple penetration contact elements for contacting the flat cable without stripping insulation, wherein the junction box comprises connection elements which electrically connect the penetration contact elements to socket contacts via the connection elements. The socket contacts electrically connect a plug plugged into the socket to cores of the flat cable. The flat cable can be put into an area of the junction box that is separate from the socket and upon actuating a clamping mechanism the penetration contact elements contact the cores of the flat cable without stripping insulation.

### FIELD OF THE INVENTION

The invention relates to a socket connection system.

### BACKGROUND OF THE INVENTION

U.S. Pat. No. 9,437,978 B2 provides a system for providing electrical energy and associated components. A universal module is presented which is adapted to fit into a common junction box used in building construction. For example, the cable connected to an apartment is connected to the module which provides a variety of locations for accommodation of electrical connections of a socket or a switch. The modules quickly and safely accommodate an electrical component, thereby reducing the time requirement and costs associated with installation, modification or repair.

### SUMMARY OF THE INVENTION

A first aspect of the invention relates to a connection system for a socket, wherein the connection system comprises a junction box for electrically connecting the socket to a flat cable as a through-line and wherein the socket can be placed directly onto the junction box. The junction box comprises multiple penetration contact elements for contacting the flat cable without stripping insulation, wherein the junction box comprises connection elements which electrically connect the penetration contact elements to socket contacts. The socket contacts electrically connect a plug plugged into the socket to cores of the flat cable via the connection elements. The flat cable can be put into an area of the junction box that is separate from the socket and upon actuating a clamping mechanism the penetration contact elements contact the cores of the flat cable without stripping insulation.

A second aspect relates to an installation kit comprising at least one through-line formed by a flat cable and at least one connection system according to the first aspect in order to connect the flat cable to sockets at predefined locations by means of the connection system.

### GENERAL EXPLANATION, ALSO RELATING TO OPTIONAL EMBODIMENTS OF THE INVENTION

The first aspect relates to a connection system for a socket. The connection system comprises a junction box for electrically connecting the socket to a flat cable as a through-line. The flat cable is designed with multiple cores—and comprises, for example, one to three phase conductor cores, a neutral conductor core and a protective conductor core. The socket can be a multi-pole socket with a neutral conductor and a protective conductor connection.

The socket can be placed directly onto the junction box. Ultimately, an electrical connection should be established between a plug inserted into the socket and the flat cable via the socket placed onto the junction box-possibly also via a socket adapter.

The junction box comprises multiple penetration contact elements for contacting the flat cable without stripping insulation. The penetration contact elements penetrate the insulation of a flat cable core and contact the associated core conductor. The penetration contact elements can be designed as contact blades, (double-sided) contact cutting edges, spikes, multiple spikes, etc.

One penetration contact element can be provided per flat cable core, for example in the case of a three-core flat cable, one penetration contact element per flat cable core, thus a total of three penetration contact elements, e.g. three contact blades or three contact spikes. Likewise, multiple penetration contact elements (e.g. two or three contact blades/spikes per flat cable core) can be provided for each flat cable core for contacting without stripping insulation. Especially with relatively high current intensities and correspondingly high conductor cross-sections, the use of multiple penetration contact elements per flat cable core can prove advantageous.

The socket placed onto the junction box is mounted on the flat cable by piercing contact and is simultaneously contacted without having to remove the insulation layer of a cable. This means that the placed socket is ready for use immediately after mounting. The installation can even be completed within a minute, or at least within a few minutes. Installation errors are virtually eliminated by the simultaneous contact of all desired flat cable cores. Mounting details follow below.

The junction box comprises connection elements that electrically connect the penetration contact elements to socket contacts. These connection elements are typically made of metal. The penetration contact elements can, for example, be integrally connected to the connection elements. Likewise, the penetration contact elements, such as contact blades, spikes or the like, can be plugged onto the connection elements.

Multiple connection elements can be provided in the junction box, wherein the connection elements each have at least one penetration contact element with a connection for a socket contact of the socket. The penetration contact element, e.g. contact blade, spike, etc., can also be connected to a separate connection for the socket contact.

The socket contacts electrically connect a plug plugged into the socket to cores of the flat cable. As mentioned above, this connection is made via the connection elements and the penetration contact elements connected to them (possibly in one piece).

For example, at least one phase socket contact is connected to at least one phase conductor core of the flat cable, a neutral conductor socket contact is connected to a neutral conductor core of the flat cable and a protective conductor contact of the socket is connected to a protective conductor core of the flat cable. If multiple phase conductor cores of the flat cable and multiple phase conductor socket contacts are provided, each phase conductor core of the flat cable can also be connected to a phase conductor socket contact of a multi-phase socket each. Likewise, the flat cable may have multiple phase conductor cores, but only a selected one of these phase conductor cores may be connected to a phase conductor socket contact of a single-phase socket.

The connection elements are designed, for example, as stamped and bent parts inserted into the junction box, possibly with socket connections formed in one piece (or integrally). These stamped and bent parts can be stamped and bent from plate-shaped sheet materials. The cross-section of the connection elements (here: stamped and bent parts), for example, is selected so that the current intensities expected for the respective connection are tolerated by the stamped and bent part. At least one penetration contact element can be integrally connected to the stamped and bent part.

For example, one or more plug contacts of a plug inserted into the socket reach through to a connection of a connection element provided for this plug contact. The connection element, which is designed as a stamped and bent part, for example, can have a penetration contact element at one end and a sleeve for the socket contact or for the plug contact of the plug inserted into the socket at another end.

Thus, for example, the plug contact of a plug inserted into the socket can end in a sleeve that is integrally connected to the connection element while the penetration contact element (e.g. contact blade, spike, etc.) contacts a flat cable core at the other end of the connection element. One plug contact of a connector or all plug contacts of a connector can be accommodated each in the sleeve of an associated connection element, while the other end of the respective connection element contacts an associated core of the flat cable by means of the adjoining penetration contact element.

The connection elements can be designed as interchangeable connection elements, wherein a specific set of connection elements serves for electrical connection of the cores of the flat cable to a socket of a specific type with specific socket contacts.

The penetration of the plug contacts of a plug inserted into the socket can, for example, be carried out for socket types of the Swiss, French or UK standard (Switzerland: plug or socket type C, J; France: plug or socket type: C, E; UK plug or socket type: G).

In order to connect the socket contacts to the flat cable cores, the flat cable can be put into an area of the junction box that is separate from the socket. Thus, the flat cable is routed through the junction box as a through-line cable.

Upon actuating a clamping mechanism, penetration contact elements (e.g. the contact blades) contact the cores of the flat cable without stripping insulation.

The connection system described above makes it possible to install sockets even with just a few electricians or skilled workers. If the locations of the sockets are known, the lengths of a through-line (given by the flat cable) can be pre-assembled for an entire room. For example, the individual cores of the flat cable are designated by colours, as are the connections of the socket, to enable easy operation. The seating of the socket on the junction box can also be designed in such a way that the socket can only be placed in a specific way so that the socket contacts contact the connection elements provided for this purpose.

The described connection system for sockets is therefore suitable for (partially) prefabricated houses, and especially for wooden houses.

In a (partially) prefabricated house, for example, the flat cable can be laid around 30 cm from the zero line. The sockets can then be installed without laying cables beforehand by attaching the connection systems described herein to the desired socket locations. The flat cable can then be inserted into the previously installed junction box of the connection device at the desired socket standard location.

The electrical connection between the socket and the junction box is then established by actuating the clamping mechanism on the junction box. This connection can be designed to be detachable, for example in that after releasing the clamping mechanism the flat cable can be removed from the junction box again.

In a wooden house, cable ducts, each of which has a flat cable put into, for example, can be laid directly into the walls and integrated already during the construction of the wooden house. The flat cable can be pulled out of the cable duct at the desired socket location using a hook in order to insert it into the junction box.

In some embodiments, an insulating body is provided in the junction box between the placed socket and the flat cable.

Optionally, multiple connections for socket contacts can be provided on the side of the insulating body facing the socket, wherein the connections for the socket contacts are arranged on the side of the insulating body facing the socket in such a way that the connections contact the socket contacts of a socket of a specific type placed onto the junction box.

The insulating body is arranged between a holder for the flat cable and the socket placed onto the junction box. The connection elements connect, for example, the connection pieces for the penetration contact elements and the connection pieces for the placed socket. The connection elements can also be manufactured in one piece with the connection pieces-for example, a connection element can merge into a penetration contact element (e.g. contact blade, spike, etc.) on one side and into a connection piece for the socket contacts on the other side.

For example, multiple connection elements are kept spaced apart from each other and insulated from each other by the insulating body. The connection pieces for the penetration contact elements or for the socket contacts can also be provided fixedly on the insulating body, wherein a specific connection piece for a socket contact can be connected to a specific connection piece for a penetration contact element via electrical connection channels within the insulating body. The respective connection channels between a specific connection for the socket contact and a specific penetration contact element form the respective connection elements.

Multiple sets of connections for socket contacts of sockets of a specific type can be provided, wherein a specific set of connections is associated with a specific socket type each, wherein different socket types can be electrically connected to the flat cable by means of the junction box.

The connections for the socket contacts can correspond to the connection pieces of the insulating body mentioned above. The insulating body can therefore serve as an intermediate piece between the flat cable and sockets of different types. For example, various plug shapes (plug types) can be connected to this intermediate piece-including various earthing systems or protective conductor systems.

The compatibility of the connections of the socket contacts can correspond, for example, to the UK standard (plug, socket type G), US standard plug socket (plug, socket type A, B), DE standard (plug, socket type C, F “Schuko socket” or type E, F), FR standard socket (plug, socket type C, E), or Swiss standard (plug, socket type C, J). In principle, different socket contacts can be arranged, for example on the insulating body, at such distances from one another that simultaneous compatibility of the connection system with different socket types is ensured. Compatibility can refer to any socket type.

The above-mentioned socket of a specific type is then accordingly a socket according to Swiss standard, a socket according to German standard, in particular a Schuko socket, a socket according to French standard, according to UK standard or according to US standard.

As mentioned above, electrical connections are arranged in the intermediate piece (i.e. in the insulating body) in the manner of a metal matrix in order to connect specific connection pieces for specific socket contacts to the respective associated cable core of the flat cable. In some embodiments, at least one plug contact of a plug inserted into the socket ends at a connection provided for this plug contact on the insulating body.

It is also possible to have a design in which, for the purpose of use with different socket types, an adapter adapted to the respective socket type is provided, which lies between the socket to be placed and the actual junction box and is inserted into the junction box.

In this design, for example, it is an adapter between different socket types, such as an adapter between a socket according to Swiss standard (plug, socket type C, J) and a socket according to German standard (plug, socket type C, F “Schuko socket” or type E, F). Swiss plug contacts (plug, socket type C, J) can also be laid on connections designed for this socket type without an adapter. On the other hand, socket contacts according to the German standard (plug, socket type C, F “Schuko socket”) can also be connected to connections for Swiss sockets (plug, socket type C, J) using an adapter. The adapters in front of the sockets make it possible to use sockets of any type, even if the connections within the junction box are intended for a different specific socket type.

Alternatively or additionally, the socket itself can be a multifunctional socket which provides plug contacts for plugs of different types.

For example, the socket has a neutral conductor contact and a phase conductor contact according to Swiss and German standard (these contacts can typically be identical), but separately a protective conductor contact according to Swiss standard and a protective conductor contact according to DE standard (Schuko connection).

In variants with an additional optional data connection, the flat cable has at least one phase conductor, a neutral conductor, a protective conductor and preferably at least one data conductor as a cable core. The junction box has corresponding connections with which the attached socket can be connected to the corresponding cable core via the junction box. In such a design, data cables can also be tapped without stripping insulation-these data cables can be connected, for example, directly to a blinds motor or to a socket with a data contact via the connection system described herein. These can be KNX type data interfaces.

The junction box can comprise a lever element as a clamping element, wherein upon actuation of the lever element the penetration contact elements are pressed into the flat cable in order to contact the flat cable without stripping insulation. The lever element can be attached to lever joints on the outer sides of the junction box and designed to press, e.g., penetration contact elements protruding from the insulating body together with the insulating body in the direction of the flat cable put into the junction box. The anchoring of the lever joints can be provided in particular on the outer sides of the insulating body or the insulating body part (see below). The penetration contact elements finally penetrate the insulation of the flat cable and contact the corresponding cores of the flat cable.

The junction box can be constructed in multiple parts. A first part of the junction box, through which the flat cable is passed, has, e.g., anchoring elements to anchor the first part of the junction box (resting part) in a wall opening. A second part of the junction box (insulating body part) comprises the penetration contact elements and the clamping mechanism and can be placed onto the first part of the junction box.

The first part of the junction box, also referred to herein as the resting part, can be anchored to a wall opening using screws, for example, and can be united with the second part of the junction box, also referred to here as the insulating body part, via a plug-in contact system. The clamping mechanism or the clamping element is designed, for example, as a lever on the insulating body part of the junction box and presses the insulating body part of the junction box with the penetration contact elements in the direction of the resting part of the junction box into which the flat cable is put in order to contact the flat cable by means of the penetration contact elements without stripping insulation.

A further aspect relates to a socket installation comprising a flat cable, at least one connection system connected to the flat cable without stripping insulation according to the first aspect described above, and a socket placed onto the at least one connection system.

A yet further aspect relates to an installation kit comprising at least one through-

line formed by a flat cable and at least one connection system according to the first aspect described above in order to connect the flat cable to sockets at predefined locations by means of the connection system.

### BRIEF DESCRIPTION OF THE DRAWINGS

The drawing serves to illustrate the socket connection system described above, the socket installation described above and the installation kit described above by means of exemplary embodiments. In the drawings:

FIG. 1 schematically shows a slotted wall with a cable duct running in the wall, which is accessible through a wall opening,

FIG. 2 schematically shows a socket placed onto the wall opening shown in FIG. 1, which is connected to a flat cable guided through the cable duct,

FIG. 3 schematically shows a socket that can be connected to a flat cable by the connection system described herein,

FIG. 4 schematically shows the socket from FIG. 3 over a flat cable,

FIG. 5 schematically shows a socket placed onto a two-part junction box above a flat cable, wherein the junction box has a wall anchoring on both sides,

FIG. 6 schematically shows a plan view of the junction box with connections for the socket placed onto the junction box and connection elements to the flat cable which end in these connections—the flat cable is here guided through the multi-part junction box,

FIG. 7 schematically shows the junction box in a plan view, wherein the junction box is mounted in the wall opening via anchoring elements,

FIG. 8 schematically shows the resting part of the junction box, via which the entire junction box is anchored in the wall opening, together with a flat cable which is guided through the resting part of the junction box and rests on a resting surface of the resting part of the junction box,

FIG. 9 schematically shows a resting part of the junction box with one-sided wall anchoring,

FIG. 10 schematically shows the resting part of the junction box from FIG. 9 with a hook placed onto it as an mounting aid, wherein the resting part of the junction box is anchored to the wall with screws inserted therein,

FIG. 11 schematically shows the resting part of the junction box from FIG. 10, wherein the wall anchor is loosened in order to change the position of the junction box relative to the wall,

FIG. 12 schematically shows the resting part of the junction box from FIG. 11 with the flat cable put therein,

FIG. 13 schematically shows a complete connection system with a socket placed onto the junction box and a flat cable guided through the junction box,

FIG. 14 schematically shows a junction box with a lever element and a two-part insulating body and penetration contact elements protruding from the latter, which can be pressed into the flat cable guided through the junction box via the lever element, in a side view,

FIG. 15 schematically shows the junction box from FIG. 14 in plan view,

FIG. 16 schematically shows the two-part insulating body with connections for the socket and lever element mounted on it,

FIGS. 17 and 18 schematically show one or more connection systems together with sockets mounted thereon and the flat cable thus contacted,

FIG. 19 shows a multifunctional socket, which serves as a socket according to

both the German standard (Schuko) and the Swiss type.

### DESCRIPTION OF EMBODIMENTS WITH THE AID OF THE DRAWINGS

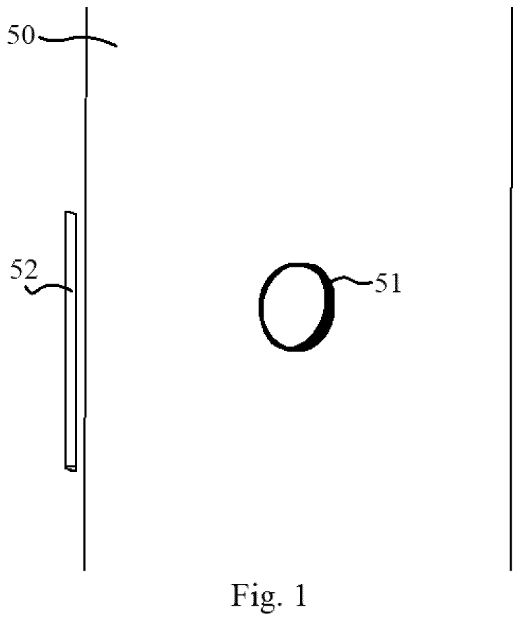

A slotted wall 50 with a cable duct 52 running in the wall 50 and accessible through a wall opening 51 is schematically shown in FIG. 1.

The cable duct 52 runs behind the wall 50 and is accessible through the opening 51.

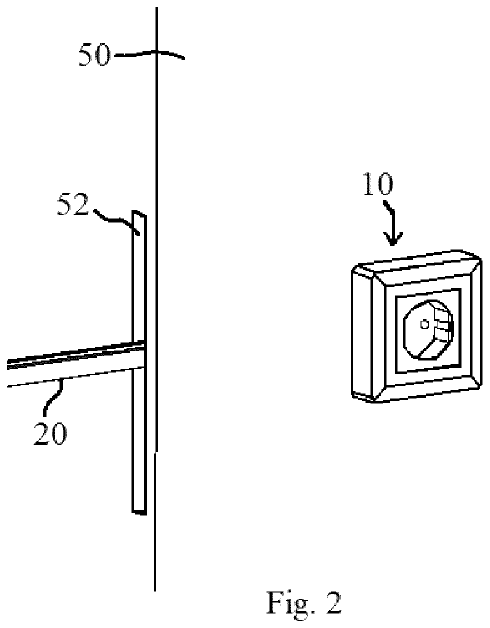

A socket 10 placed onto the wall opening 51 shown in FIG. 1, which is connected to a flat cable 20 guided through the cable duct 52, is schematically depicted in FIG. 2.

The flat cable 20 runs along a cable duct across the wall 50 and is connected to the socket 10 at the location depicted in FIG. 2.

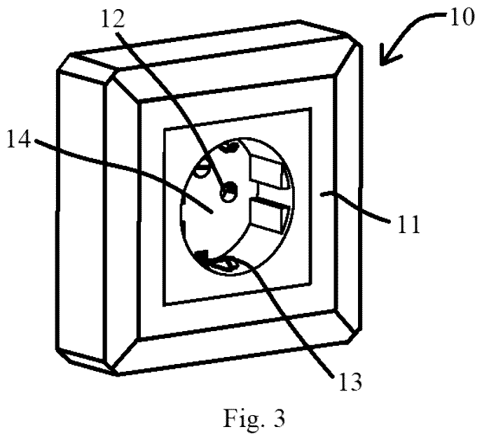

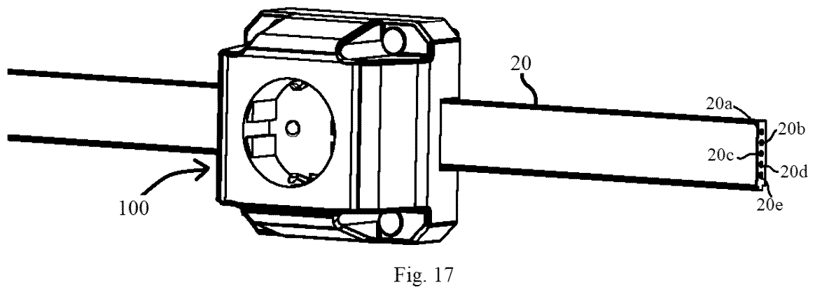

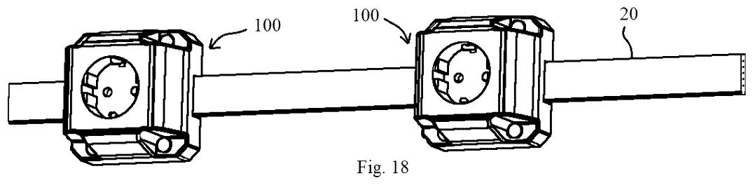

An example of a socket 10 that can be connected to a flat cable by the connection system 100 described herein (see FIG. 17 and FIG. 18) is schematically depicted in FIG. 3.

The socket 10 has a cover 11, as well as a neutral or phase conductor contact 12 and a protective contact (PE contact) 13. The socket is shown as a Schuko socket, which is commercially available in Germany, for example.

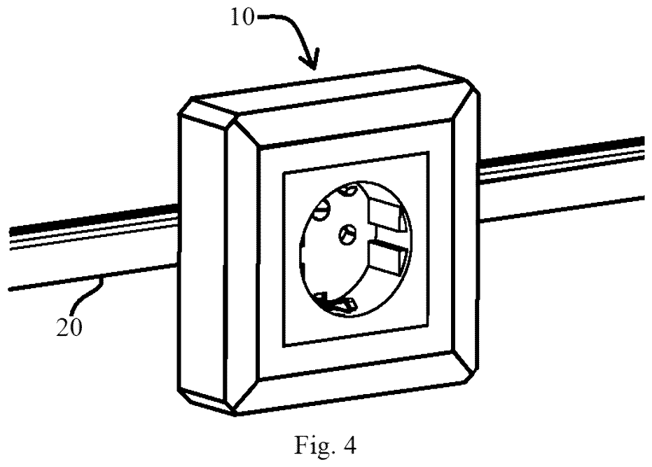

The socket 10 from FIG. 3 is schematically depicted in FIG. 4 above a flat cable 20.

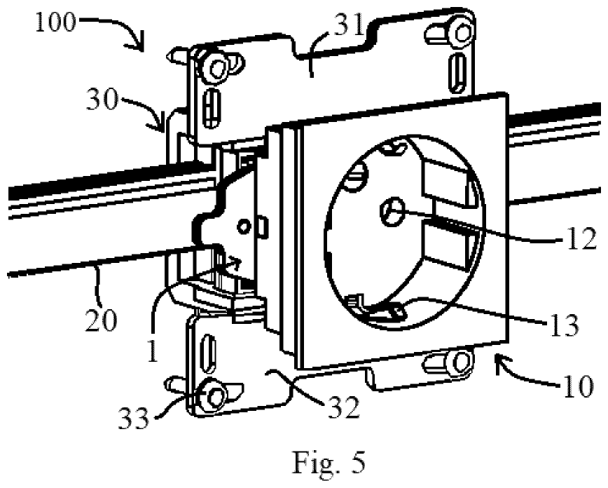

An example of a socket 10 placed onto a two-part junction box 1 above a flat cable 20, wherein the junction box 1 has a wall anchoring 31, 32 on both sides, is schematically depicted in FIG. 5.

Here, a resting part 30 of the junction box 1 is provided with two lateral wall anchorings 31, 32, which can be anchored in a wall via screws 33 (see FIGS. 1 and 2). The flat cable 20, the junction box 1 and the socket 10, for example, provide the connection system 100 described herein.

The flat cable 20 is guided through the resting part 30 of the junction box and rests on a resting surface which, when installed, typically runs parallel to the wall and the cable duct behind it (see FIGS. 1 and 2).

The socket 10 is placed onto the junction box 1 in such a way that its neutral conductor or phase conductor contacts 12 and the protective conductor contacts 13 are electrically connected to the cores of the flat cable 20 (see FIG. 17). In the example, the neutral conductor core of the flat cable 20 is connected to the neutral conductor connection of the socket 10 and the phase conductor core of the flat cable 20 is connected to the phase conductor of the socket 10, just as the protective conductor core of the flat cable 20 is connected to the protective contact 13 of the socket. A representation of the cable cores of the flat cable can be found in FIG. 17.

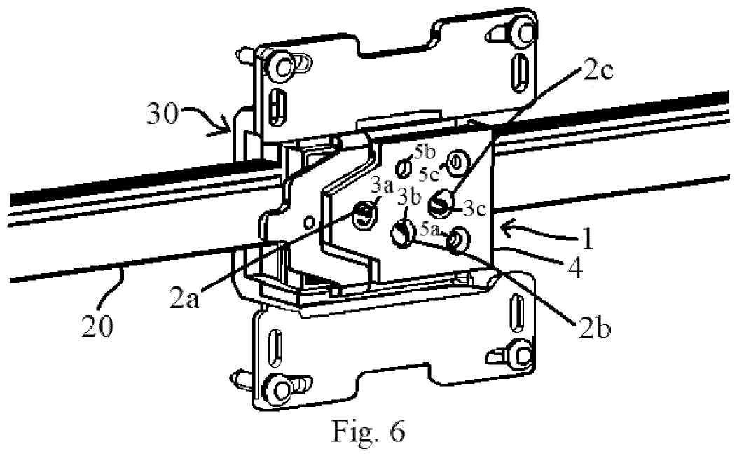

The junction box 1 is depicted in FIG. 6 in a plan view with connections for the socket 2a to 2c and 5a to 5c, respectively, placed onto the junction box and connection elements to the flat cable which end in these connections-the flat cable 20 is here guided through the multi-part junction box.

As before, the flat cable 20 is guided through a resting part 30 of the junction box 1. The top of the junction box 1 has an insulating template 4 with various connections 2a to 2c and 5a to 5c designed as openings.

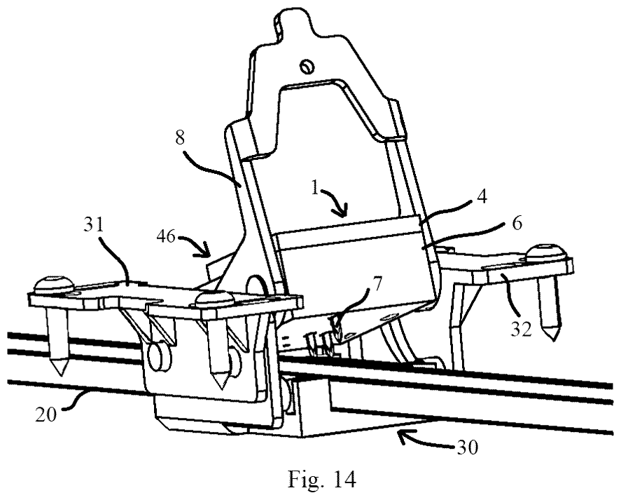

The connections 2a to 2c on the top of the junction box 1, which are formed in a template 4, lead to corresponding connection elements 3a to 3c, which at one end end in the connections 2a to 2c, but at the other end are connected, for example in one piece, to penetration contact elements 7 (eg contact blades, spikes, etc.) (see FIG. 14). For example, connections 2a to 2c are intended for sockets according to Swiss standard. The connections 5a to 5c can be selected so that other sockets, for example sockets according to UK standard, US standard or DE standard, can be electrically connected to the flat cable 20 via the junction box 1.

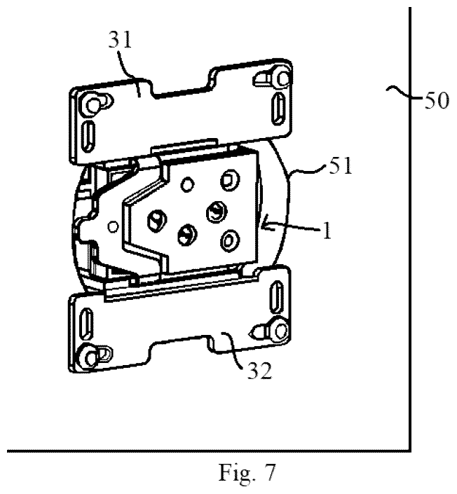

The junction box 1 from FIG. 6 is schematically shown in a plan view in FIG. 7, wherein the junction box 1 is mounted via its anchoring elements 31, 32 in the wall opening 51 on the wall 50.

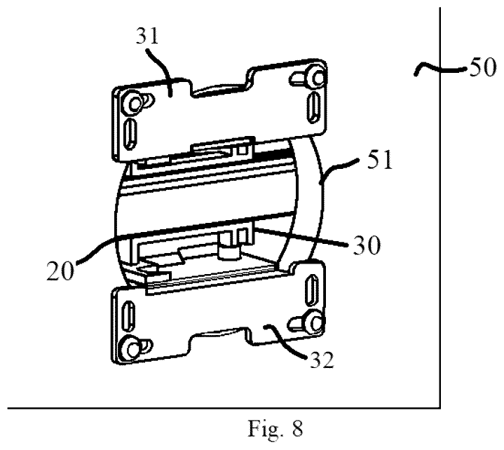

The resting part 30 of the junction box, via which the entire junction box is anchored in the wall opening, together with a flat cable 20 which is guided through the resting part 30 of the junction box and rests on a resting surface of the resting part 30 of the junction box, schematically shown in FIG. 8. The resting part 30 is anchored on both sides by anchoring elements 31, 32 via screws at the perimeter of the wall opening 51.

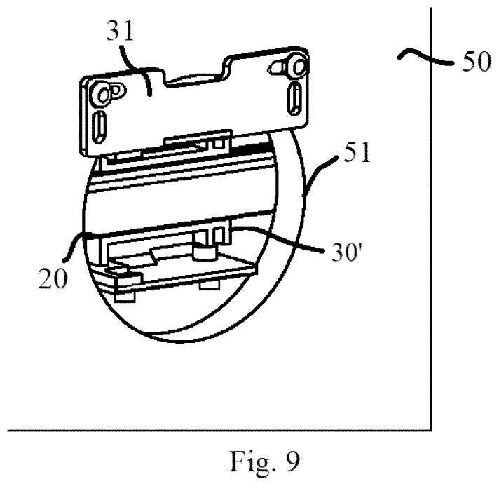

An embodiment of the resting part 30′ of the junction box with one-sided wall anchoring 31 is schematically shown in FIG. 9. The resting part 30′ of the junction box can be identical to the resting part 30 of the junction box shown in FIG. 8, except for the absence of a wall anchoring 32 on the opposite side of the wall anchoring 31. The two wall anchorings 31, 32 (see FIG. 8) can be designed to be removable, so that at least one of the two wall anchorings 31, 32 (see FIG. 8) can be removed in order to retrieve the flat cable 20 from the wall opening 51 or to insert it into the wall opening.

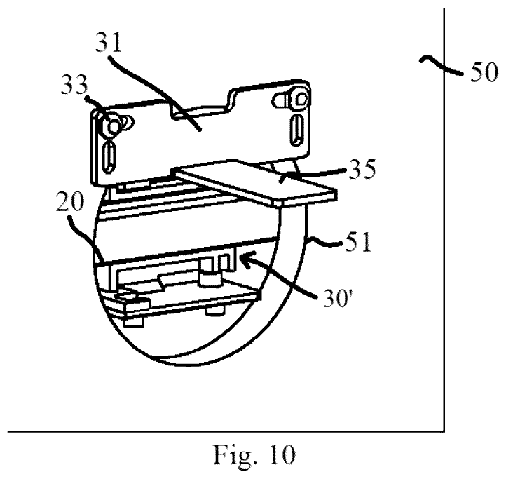

The resting part 30′ of the junction box from FIG. 9 with a hook 35 placed onto it as an mounting aid, wherein the resting part 30′ of the junction box is anchored to the wall with screws inserted therein, is schematically depicted in FIG. 10 The hook 35 can be used to either insert the flat cable together with the resting part 30′ of the junction box into the wall opening 51 or to retrieve it from the wall opening 51.

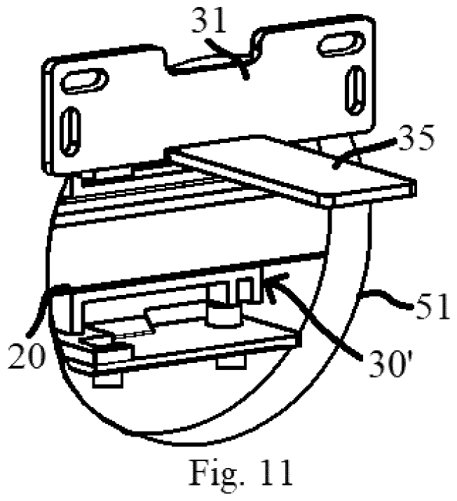

Such a condition is schematically shown in FIG. 11, where the wall anchoring 31 of the resting part 30′ of the junction box is loosened (in FIG. 11 the screws visible in FIG. 10 are removed) in order to change the position of the junction box relative to the wall.

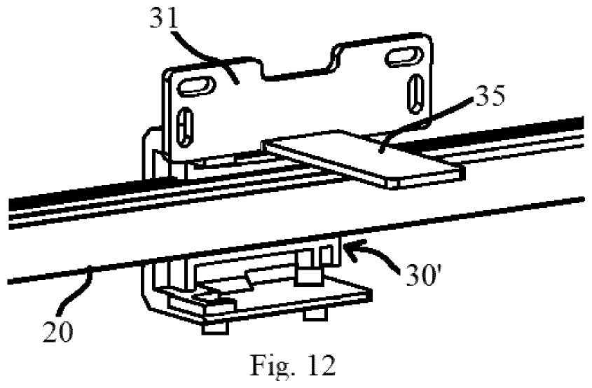

The resting part 30′ of the junction box from FIG. 11 with the flat cable 20 put therein is schematically depicted in FIG. 12. The depiction in FIG. 12 shows the flat cable 20 put into the resting part 30′ of the junction box outside a wall opening 51.

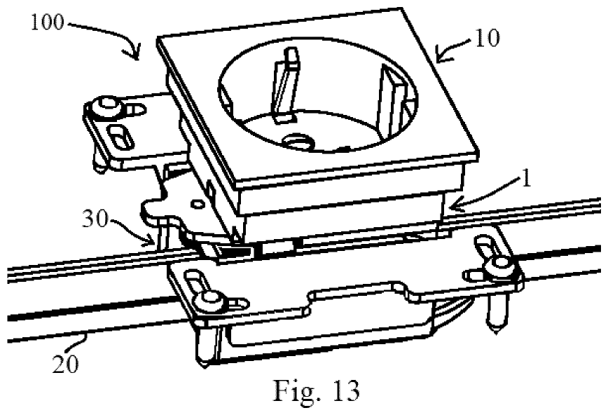

A complete connection system 100 with a socket 10 placed onto the junction box 1 and a flat cable 20 guided through the junction box 1 is depicted in FIG. 13. The flat cable 20 here is guided through the resting part 30 of the junction box 1.

A junction box 1 with a lever element 8 and a two-part insulating body 46 and penetration contact elements 7 protruding from the latter, which can be pressed into the flat cable 20 guided through the junction box 1 via the lever element 8, is depicted in FIG. 14 in a side view.

The flat cable 20 rests on a support surface of the resting part 30 of the junction box 1. Penetration contact elements 7 protrude from a first part 6 of the insulating body 46 in the direction of the flat cable 20. The penetration contact elements 7 are, for example, integrally joined to connection elements 3a to 3c (see FIG. 6) or are connected to them in a modular manner.

The connection elements 3a to 3c (see FIG. 6) extend, for example for each of the penetration contact elements 7, separately from one another within the first part 6 (carrier for the penetration contact elements) of the insulating body 46 up to the template 4 with the connections (see FIG. 6). The template 4 and the first part 6 (carrier for the penetration contact elements) together form an insulating body 46 in which the connection elements 3a to 3c run electrically separated from one another.

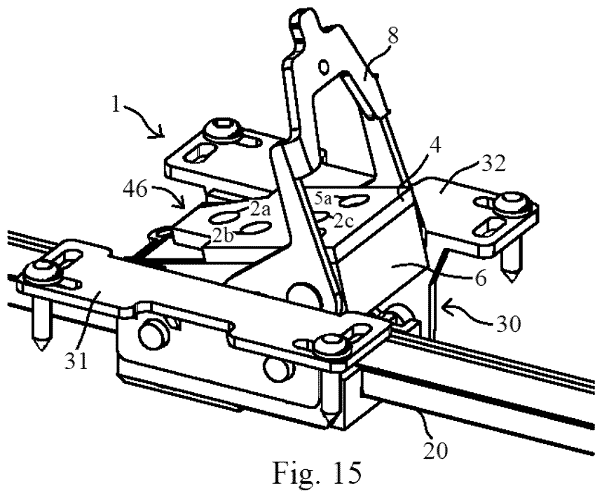

A lever element 8 is mounted on both sides of the insulating body 46. The lever element 8 serves as a clamping element to press the insulating body 46 with the penetration contact elements 7 upon activation in the direction of the flat cable 20, thus in the direction of the resting part 30 of the junction box 1, in order to contact the cores of the flat cable 20 without stripping insulation and thus to put the flat cable cores via the connection elements 3a to 3c to the connections shown in FIG. 6 and FIG. 15 for the socket 10 (see e.g. FIG. 13), onto which the socket 10 is then placed.

The junction box from FIG. 14 is depicted in FIG. 15 in plan view. In this plan view, the connections 2a to 2c or 5a etc. are shown on the template 4 as second part of the two-part insulating body 46.

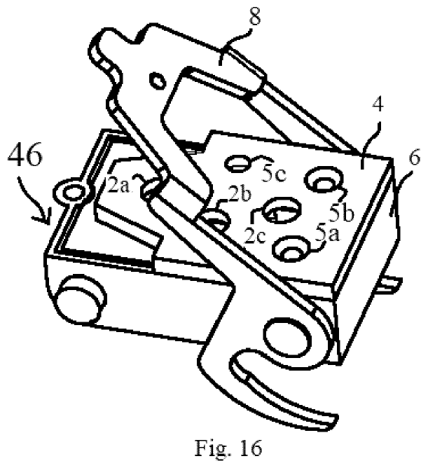

The multi-part insulating body 46 with connections 2a to 2c or 5a to 5c for the socket (for example connections 3a to 3c for sockets according to Swiss standard) on the template 4 and the lever element 8 mounted thereon is depicted separately again in FIG. 16.

For example, connections 2a to 2c are intended for sockets according to Swiss standard. The connections 5a to 5c can be selected so that other sockets, for example sockets according to UK standard, US standard or DE standard, can be electrically connected to the flat cable 20 via the junction box 1.

One or more connection systems 100 together with the sockets mounted thereon and the flat cable 20 thus contacted are depicted in FIG. 17 and FIG. 18.

The flat cable 20 here has five cable cores 20a, 20b, 20c, 20d, 20e. The cable cores 2a-2c are, for example, phase conductors, while the cable core 20d is, for example, a neutral conductor and the cable core 20e is, for example, a protective conductor.

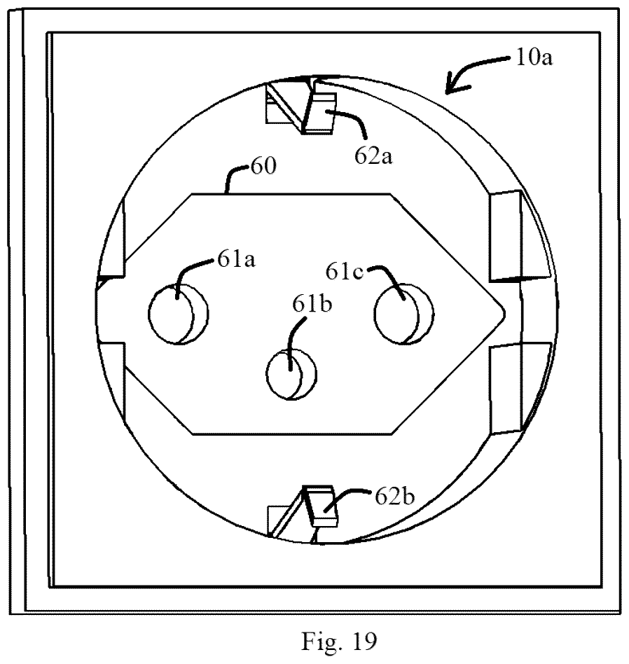

A multifunctional socket 10a, which serves as a socket according to both the German standard (Schuko) and the Swiss type, is depicted in FIG. 19.

The multifunctional socket 10a has an adapter 60, which is compatible with both the German standard and the Swiss standard. The socket openings 61a, 16b, 61c, as well as the protective conductor contacts 62a, 62b are compatible with plugs according to the Swiss standard as well as with plugs according to the DE standard. The Swiss plug contacts the openings 61a, 61b, 61c, the DE plug contacts the openings 61a, 61c, as well as the protective contacts 62a, 62b.

1. A connection system for a socket, wherein the connection system comprises:
a junction box for electrically connecting the socket to a flat cable as a through-line, wherein the socket can be placed directly onto the junction box, wherein the junction box comprises penetration contact elements for contacting the flat cable without stripping insulation, wherein the junction box comprises connection elements that electrically connect the penetration contact elements to socket contacts, wherein the socket contacts electrically connect a plug plugged into the socket to cores of the flat cable via the connection elements, wherein the flat cable can be put into an area of the junction box that is separate from the socket and upon actuating a clamping mechanism the penetration contact elements contact the cores of the flat cable without stripping insulation.

2. The connection system according to claim 1, wherein the connection elements are provided in the junction box, wherein the connection elements each have at least one of the penetration contact elements with a connection for one of the socket contacts of the socket.

3. The connection system according to claim 2, wherein at least one plug contact of the plug inserted into the socket reaches through to contact one of the connection elements.

4. The connection system according to claim 1, wherein the connection elements are interchangeable, wherein a specific set of connection elements serves for electrical connection of the cores of the flat cable to the socket of a specific type with specific socket contacts.

5. The connection system according to claim 1, wherein an insulating body is provided between the placed socket and the flat cable.

6. The connection system according to claim 5, wherein multiple connections for socket contacts are provided on the side of the insulating body facing the socket in such a way that the connections contact the socket contacts of the socket of a specific type placed onto the junction box.

7. The connection system according to claim 6, wherein multiple sets of connections for socket contacts of sockets of a specific type are provided, wherein a specific set of connections is associated with a specific socket type, respectively, wherein different socket types can be electrically connected to the flat cable by means of the junction box.

8. The connection system according to claim 5, wherein at least one plug contact of the plug inserted into the socket ends at a connection provided for the plug contact on the insulating body.

9. The connection system according to claim 5, wherein the socket is of the specific type according to Swiss standard, according to German standard, in particular a Schuko socket, according to French standard, according to UK standard, or according to US standard.

10. The connection system according to claim 1, wherein the socket is a multifunctional socket which provides plug contacts for plugs of different types, in particular for plugs according to Swiss standard and German standard.

11. The connection system according to claim 1, wherein the flat cable comprises at least one phase conductor, a neutral conductor, a protective conductor and preferably at least one data conductor as a cable core and corresponding connections of the placed socket are connected via the junction box to the respectively associated cable core.

12. The connection system according to claim 1, wherein the junction box comprises a lever element as the clamping mechanism, wherein upon actuation of the lever element the penetration contact elements are pressed into the flat cable in order to contact the cores of the flat cable without stripping insulation.

13. The connection system according to claim 1, wherein the junction box is constructed in multiple parts and a first part of the junction box, through which the flat cable is passed, has anchoring elements in order to anchor a lower part of the junction box in a wall opening, and wherein a second part of the junction box, which comprises an insulating body, comprises the penetration contact elements and the clamping mechanism and can be placed onto the first part of the junction box.

14. The connection system according to claim 13, wherein the clamping mechanism comprises a lever element that is mounted on outer sides of the second part of the junction box which comprises the insulating body.

15. A socket installation, comprising:
a flat cable;
at least one connection system according to claim 1, connected to the flat cable without stripping insulation; and
a socket placed onto the at least one connection system.

16. An installation kit, wherein the installation kit comprises:
at least one through-line formed by a flat cable;
at least one socket; and
at least one connection system according to claim 1 in order to connect the at least one socket to the flat cable at predefined locations by means of the at least one connection system.
